(19) United States
(12) Patent Application Publication
(10) Pub. No.: US 2025/0301154 A1
(43) Pub. Date: Sep. 25, 2025

(54) VIDEO ENCODING AND DECODING PROCESSING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Kuan TIAN, Shenzhen (CN); Jun ZHANG, Shenzhen (CN); Jinxi XIANG, Shenzhen (CN)

(21) Appl. No.: 19/228,298

(22) Filed: Jun. 4, 2025

Related U.S. Application Data
(63) Continuation of application No. PCT/CN2024/082916, filed on Mar. 21, 2024.

(30) Foreign Application Priority Data
May 10, 2023 (CN) 202310519260.9

(51) Int. Cl. H04N 19/167; H04N 19/14; H04N 19/172; H04N 19/86

(52) U.S. Cl. CPC H04N 19/167; H04N 19/14; H04N 19/172; H04N 19/86

(57) ABSTRACT

A method includes: extracting a video frame sequence from a sample video, the video frame sequence including a key frame and an estimated frame; performing encoding and decoding processing on the key frame via a pre-trained key frame network of a video encoding and decoding model, to obtain a first encoded frame and a corresponding first reconstructed frame; performing encoding and decoding processing on the estimated frame via a pre-trained estimated frame network of the video encoding and decoding model, to obtain a second encoded frame and a corresponding second reconstructed frame; performing model optimization on the video encoding and decoding model based on the first encoded frame, the first reconstructed frame, the second encoded frame, and the second reconstructed frame, to obtain a target video encoding and decoding model; and performing encoding and decoding processing on a target video by using the target video encoding and decoding model.

### CROSS-REFERENCE TO RELATED APPLICATIONS

This application is a continuation of International Application No. PCT/CN2024/082916, filed on Mar. 21, 2024, which claims priority to Chinese Patent Application No. 2023105192609, entitled “VIDEO ENCODING AND DECODING PROCESSING METHOD AND APPARATUS, COMPUTER DEVICE, AND STORAGE MEDIUM” filed on May 10, 2023, the entire contents of both of which are incorporated by reference.

### FIELD OF THE TECHNOLOGY

This application relates to the field of computer technologies, and in particular, to a video encoding and decoding processing method and apparatus, a computer device, and a storage medium.

### BACKGROUND OF THE DISCLOSURE

Video data usually has a relatively large data amount. If the original video data is directly transmitted, a large amount of network bandwidth and storage space are occupied. With a video encoding and decoding technology, the video data may be compressed and decompressed, to effectively transmit and store the video data. With the continuous development of artificial intelligence technologies, a deep learning video encoding and decoding technology based on a neural network has been gradually applied to the field of video transmission.

However, for an existing video encoding and decoding model, there are problems such as video quality degradation and an increase in a bit rate when encoding and decoding are performed on a high-definition video and an ultra high-definition video, causing a poor encoding and decoding effect of the existing video encoding and decoding model.

### SUMMARY

In accordance with the disclosure, there is provided a video encoding and decoding processing method including extracting a video frame sequence including a key frame and an estimated frame from a sample video, performing encoding and decoding processing on the key frame via a pre-trained key frame network of a video encoding and decoding model to obtain a first encoded frame and a first reconstructed frame, performing encoding and decoding processing on the estimated frame via a pre-trained estimated frame network of the video encoding and decoding model to obtain a second encoded frame and a second reconstructed frame, performing model optimization on the video encoding and decoding model based on the first encoded frame, the first reconstructed frame, the second encoded frame, and the second reconstructed frame, to obtain a target video encoding and decoding model, and performing encoding and decoding processing on a target video using the target video encoding and decoding model.

Also in accordance with the disclosure, there is provided a computer device including a processor and a memory storing computer-readable instructions that, when executed by the processor, cause the computer device to extract a video frame sequence including a key frame and an estimated frame from a sample video, perform encoding and decoding processing on the key frame via a pre-trained key frame network of a video encoding and decoding model to obtain a first encoded frame and a first reconstructed frame, perform encoding and decoding processing on the estimated frame via a pre-trained estimated frame network of the video encoding and decoding model to obtain a second encoded frame and a second reconstructed frame, perform model optimization on the video encoding and decoding model based on the first encoded frame, the first reconstructed frame, the second encoded frame, and the second reconstructed frame, to obtain a target video encoding and decoding model, and perform encoding and decoding processing on a target video using the target video encoding and decoding model.

Also in accordance with the disclosure, there is provided a non-transitory computer-readable storage medium storing computer-readable instructions stored that, when executed by a processor, cause a computer device having the processor to extract a video frame sequence including a key frame and an estimated frame from a sample video, perform encoding and decoding processing on the key frame via a pre-trained key frame network of a video encoding and decoding model to obtain a first encoded frame and a first reconstructed frame, perform encoding and decoding processing on the estimated frame via a pre-trained estimated frame network of the video encoding and decoding model to obtain a second encoded frame and a second reconstructed frame, perform model optimization on the video encoding and decoding model based on the first encoded frame, the first reconstructed frame, the second encoded frame, and the second reconstructed frame, to obtain a target video encoding and decoding model, and perform encoding and decoding processing on a target video using the target video encoding and decoding model.

### BRIEF DESCRIPTION OF THE DRAWINGS

To describe the technical solutions in the embodiments of this application or in the conventional technology more clearly, the following briefly describes the accompanying drawings required for describing the embodiments or the conventional technology. Apparently, the accompanying drawings in the following descriptions show merely the embodiments of this application, and a person of ordinary skill in the art may still derive other drawings from the disclosed accompanying drawings without creative efforts.

FIG. 1 is a diagram showing an application environment of a video encoding and decoding processing method according to an embodiment.

FIG. 2A is a schematic flowchart of a video encoding and decoding processing method according to an embodiment.

FIG. 2B is a schematic flowchart of a video encoding and decoding processing method according to another embodiment.

FIG. 3 is a schematic diagram showing a sample video according to an embodiment.

FIG. 4 is a schematic flowchart of a key frame network training operation according to an embodiment.

FIG. 5 is a schematic flowchart of an estimated frame network training operation according to an embodiment.

FIG. 6 is a schematic flowchart of a model parameter optimization operation according to an embodiment.

FIG. 7 is a schematic flowchart of a loss value determining operation according to an embodiment.

FIG. 8 is a schematic flowchart of a model testing operation according to an embodiment.

FIG. 9 is a schematic diagram showing a reconstruction evaluation result according to an embodiment.

FIG. 10 is a schematic flowchart of a target video encoding and decoding operation according to an embodiment.

FIG. 11 is a schematic flowchart of a video encoding and decoding processing method according to another embodiment.

FIG. 12 is a schematic flowchart of a video encoding and decoding processing method according to another embodiment.

FIG. 13 is a schematic flowchart of a video encoding and decoding model training operation according to an embodiment.

FIG. 14 is a schematic flowchart of a video encoding and decoding model training operation according to another embodiment.

FIG. 15 is a structural block diagram of a video encoding and decoding processing apparatus according to an embodiment.

FIG. 16 is a structural block diagram of a video encoding and decoding processing apparatus according to another embodiment.

FIG. 17 is a diagram showing an internal structure of a computer device according to an embodiment.

FIG. 18 is a diagram showing an internal structure of a computer device according to another embodiment.

### DESCRIPTION OF EMBODIMENTS

To make the objectives, technical solutions, and advantages of this application clearer and more comprehensible, the following further describes this application in detail with reference to the accompanying drawings and embodiments. The specific embodiments described herein are merely used for explaining this application but are not intended to limit this application.

In the following descriptions, related terms “first, second, and third” are merely intended to distinguish between similar objects, and do not indicate a specific order of the objects. A specific order or sequence of the “first, second, and third” is interchangeable as permitted, so that the embodiments of this application described herein may be implemented in an order other than the order illustrated or described herein.

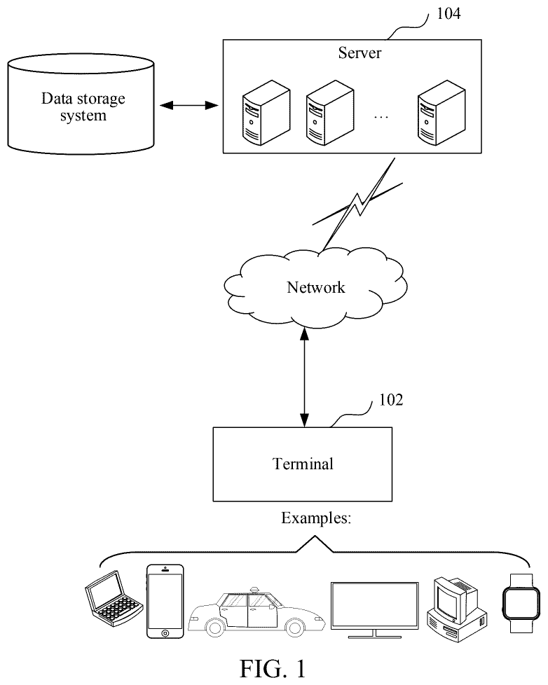

A video encoding and decoding processing method provided in an embodiment of this application may be applied to an application environment shown in FIG. 1. A terminal 102 communicates with a server 104 via a network. A data storage system may store data that the server 104 needs to process. The data storage system may be integrated on the server 104, or may be arranged on a cloud or another server. The video encoding and decoding processing method is separately performed by the terminal 102 or the server 104, or is performed by the terminal 102 and the server 104 in cooperation. In some embodiments, the video encoding and decoding processing method is performed by the terminal 102. The terminal 102 extracts a video frame sequence from a sample video, the video frame sequence including a key frame and an estimated frame. The terminal 102 performs encoding and decoding processing on the key frame via a pre-trained key frame network of a video encoding and decoding model, to obtain a first encoded frame and a corresponding first reconstructed frame. The terminal 102 performs encoding and decoding processing on the estimated frame via a pre-trained estimated frame network of the video encoding and decoding model, to obtain a second encoded frame and a corresponding second reconstructed frame. The terminal 102 performs model optimization on the video encoding and decoding model based on the first encoded frame, the first reconstructed frame, the second encoded frame, and the second reconstructed frame, to obtain a target video encoding and decoding model. The terminal 102 performs, when obtaining a target video, encoding and decoding processing on the target video by using the target video encoding and decoding model.

The terminal 102 may be, but is not limited to, a desktop computer, a notebook computer, a smartphone, a tablet computer, an Internet of Things device, or a portable wearable device. The Internet of Things device may be a smart speaker, a smart television, a smart air conditioner, a smart vehicle-mounted device, or the like. The portable wearable device may be a smart watch, a smart bracelet, a head-mounted device, or the like. The server 104 may be an independent physical server, may be a server cluster or a distributed system including a plurality of physical servers, or may be a cloud server providing a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal 102 and the server 104 may be directly or indirectly connected in a wired or wireless communication mode. This is not limited in this application herein.

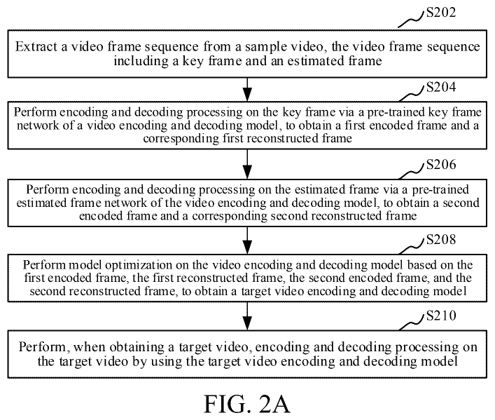

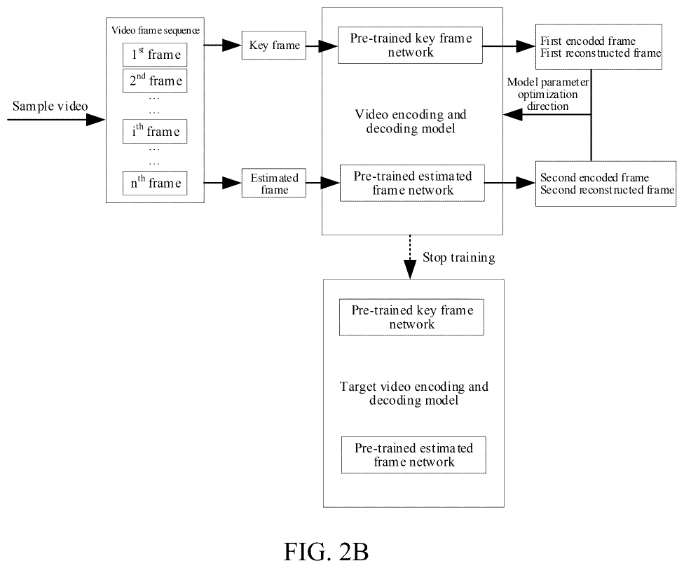

In an embodiment, as shown in FIG. 2A and FIG. 2B, a video encoding and decoding processing method is provided. An example in which the method is applied to a computer device (the terminal 102 or the server 104) in FIG. 1 is used for description, and the method includes the following operations.

S202: Extract a video frame sequence from a sample video, the video frame sequence including a key frame and an estimated frame.

The sample video is video data configured for training a machine learning model. The sample video usually includes a plurality of video frames, and each video frame includes information about video content, such as a color, a shape, and an action. The sample video may come from various sources, such as real-life video recording, a simulation-generated video, and a video on the Internet. The sample video may be a video that meets a particular condition. For example, the sample video is a video that meets a preset definition condition, that is, a definition of each video frame in the sample video may meet the preset definition condition. The definition condition refers to that a definition of a video frame image meets a specific standard or requirement.

In addition, a scene in the sample video in this embodiment of this application may be a consecutive scene. The consecutive scene refers to consecutive and similar scene content in the video, for example, content shot by a plurality of cameras in a same room, natural scenery in a period of time, and content of a speech delivered by a speaker at a platform. The consecutive scene may help to analyze a change in the scene content, identify scene conversion, extract scene information, and the like, and is significant for video analysis and application.

The video frame sequence includes a plurality of consecutive video frames. In an actual processing process, the key frame and the estimated frame may be determined according to a requirement. For example, a 1^{st} video frame in the video frame sequence may be determined as the key frame, and another video frame following the 1^{st} video frame in the video frame sequence may be determined as the estimated frame. The video frame sequence may be referred to as a group of pictures (GOP), the key frame may also be referred to as an intra-coded frame (I frame), and the estimated may also be referred to as a predicted frame (P frame). In this embodiment of this application, encoding may be performed in an alternating mode of I frames and P frames. The I frame may also be referred to as the intra-coded frame, and an encoding result obtained through encoding of the I frame includes complete picture information in an original video frame. The I frame is self-contained, meaning that the I frame may be decoded independently of another frame, and an image of the frame can be reconstructed without any external information. A GOP may include one I frame and several P frames. A 1^{st} P frame is encoded relative to the I frame, and an encoding result carries only difference information compared to the I frame. A subsequent P frame is encoded relative to a previous P frame, and an encoding result carries only difference information compared to the previous P frame. That is, an encoding result obtained through encoding of a P frame carries only difference information compared to a previous frame. In this encoding mode, a bit rate of a video can be effectively reduced, and video quality and fluency can be ensured.

Specifically, after obtaining the sample video, a terminal extracts the video frame sequence from the sample video according to a specific time interval, determines a 1^{st} frame in the video frame sequence as the key frame, and determines a video frame other than the 1^{st} frame in the video frame sequence as the estimated frame.

S204: Perform encoding and decoding processing on the key frame via a pre-trained key frame network of a video encoding and decoding model, to obtain a first encoded frame and a corresponding first reconstructed frame.

The video encoding and decoding model is a neural network model based on deep learning, and is configured to compress, decompress, reconstruct, and the like a video. For a deep learning encoding and decoding model, a model such as a convolutional neural network (CNN) or a recurrent neural network (RNN) is usually adopted.

The pre-trained key frame network is a branch of the video encoding and decoding model, and is configured to perform encoding and decoding processing on the key frame in the video frame sequence. During video encoding and decoding, the key frame is an important frame in the video frame sequence because the key frame can independently represent video content and does not need to rely on another frame. Efficient encoding and decoding processing on the key frame can significantly improve video compression efficiency and quality. The pre-trained key frame network is obtained through pre-training of a key frame network by using a deep learning technology.

Specifically, after obtaining the video frame sequence, the terminal inputs the key frame in the video frame sequence into the pre-trained key frame network of the video encoding and decoding model, and performs encoding and decoding processing on the key frame via the pre-trained key frame network, to obtain the first encoded frame corresponding to the key frame and the first reconstructed frame corresponding to the first encoded frame.

S206: Perform encoding and decoding processing on the estimated frame via a pre-trained estimated frame network of the video encoding and decoding model, to obtain a second encoded frame and a corresponding second reconstructed frame.

The pre-trained estimated frame network is another branch of the video encoding and decoding model, and is configured to perform encoding and decoding processing on a non-key frame in the video frame sequence. The pre-trained estimated frame network is obtained through pre-training of an estimated frame network by using the deep learning technology.

Specifically, after obtaining the video frame sequence, the terminal inputs the estimated frame in the video frame sequence into the pre-trained estimated frame network of the video encoding and decoding model, and performs encoding and decoding processing on the estimated frame via the pre-trained estimated frame network, to obtain the second encoded frame corresponding to the estimated frame and the second reconstructed frame corresponding to the second encoded frame.

S208: Perform model optimization on the video encoding and decoding model based on the first encoded frame, the first reconstructed frame, the second encoded frame, and the second reconstructed frame, to obtain a target video encoding and decoding model.

Specifically, after obtaining the first encoded frame, the first reconstructed frame, the second encoded frame, and the second reconstructed frame, the terminal performs parameter optimization on the video encoding and decoding model based on the first encoded frame, the first reconstructed frame, the second encoded frame, and the second reconstructed frame, and stops training when a convergence condition is met, to obtain the target video encoding and decoding model.

Convergence means that a training process of a model already tends to be stable, that is, the video encoding and decoding model has learned a feature of data, and there is no significant improvement. The convergence condition includes a fixed quantity of training rounds, a fixed threshold of a loss function, and the like. When the model meets the condition, training is stopped, so that overfitting is avoided.

S210: Perform, when obtaining a target video, encoding and decoding processing on the target video by using the target video encoding and decoding model.

The target video is a video to be encoded and decoded, and the target video may be a video from a different source and a different scene.

Specifically, the terminal may be a transmitting end or a receiving end of the target video. In a scenario in which the terminal is the transmitting end of the target video, after obtaining the target video, the terminal performs encoding processing on the target video by using the target video encoding and decoding model, to obtain an encoded byte stream, and transmits the encoded byte stream to the receiving end. In a scenario in which the terminal is the receiving end of the target video, after receiving the encoded byte stream, the terminal performs video reconstruction on the encoded byte stream by using the target video encoding and decoding model, to obtain a reconstructed target video.

In an embodiment, a process in which the terminal performs encoding processing on the target video by using the target video encoding and decoding model, to obtain the encoded byte stream includes the following operations: extracting each video frame sequence from the target video; performing encoding processing on a key frame in each video frame sequence by using an encoder of a pre-trained key frame network of the target video encoding and decoding model, to obtain a first encoded byte stream; performing encoding processing on estimated frames in a plurality of video frame sequences by using an encoder of a pre-trained estimated frame network of the target video encoding and decoding model, to obtain a second encoded byte stream; and combining the first encoded byte stream and the second encoded byte stream into the encoded byte stream. The first encoded byte stream may also be referred to as a first processed encoded frame, and the second encoded byte stream may also be referred to as a second processed encoded frame.

In an embodiment, a process in which the terminal performs video reconstruction on the encoded byte stream by using the target video encoding and decoding model, to obtain the reconstructed target video includes the following operations: performing decoding processing on the first encoded byte stream in the encoded byte stream by using a decoder of the pre-trained key frame network of the target video encoding and decoding model, to obtain a reconstructed key frame; performing decoding processing on the second encoded byte stream in the encoded byte stream by using a decoder of the pre-trained estimated frame network of the target video encoding and decoding model, to obtain a reconstructed estimated frame; and generating the reconstructed target video based on the reconstructed key frame and the reconstructed estimated frame. The reconstructed key frame may also be referred to as a first processed reconstructed frame, and the reconstructed estimated frame may also be referred to as a second processed reconstructed frame.

In the foregoing embodiments, after obtaining the video encoding and decoding model that includes the pre-trained key frame network and the pre-trained estimated frame network, the terminal does not directly process a video encoding and decoding task by using the video encoding and decoding model, but extracts the video frame sequence from the sample video, the video frame sequence including the key frame and the estimated frame, to perform encoding and decoding processing on the key frame and the estimated frame respectively in different modes, so as to ensure video compression quality and improve a video compression rate. Encoding and decoding processing is performed on the key frame via the pre-trained key frame network of the video encoding and decoding model, to obtain the first encoded frame and the corresponding first reconstructed frame. Encoding and decoding processing is performed on the estimated frame via the pre-trained estimated frame network of the video encoding and decoding model, to obtain the second encoded frame and the corresponding second reconstructed frame. Therefore, joint training on the pre-trained key frame network and the pre-trained estimated frame network of the video encoding and decoding model may be implemented based on the first encoded frame, the first reconstructed frame, the second encoded frame, and the second reconstructed frame. In other words, a parameter of the model is further optimized, so that the target video encoding and decoding model obtained through training has a better encoding and decoding capability for a video meeting a specific condition. For example, when a used sample video is a video meeting specific definition conditions (high definition and ultra high definition), and an encoding and decoding task for the target video meeting the specific definition conditions (high definition and ultra high definition) is processed by using the target video encoding and decoding model, video compression quality and a compression rate can be improved, that is, an encoding and decoding effect on a video is improved.

In an embodiment, the video encoding and decoding processing method further includes a process of obtaining the sample video, and the process of obtaining the sample video specifically includes the following operations: obtaining an original video meeting a definition condition; performing boundary detection on the original video, to obtain a scene boundary in the original video; and extracting, based on the scene boundary, a video clip including a consecutive scene from the original video as the sample video.

The definition condition refers to a set of rules or indicators configured for ensuring that selected content meets a specific visual quality standard when video or image data is processed. The original video meeting the definition condition refers to that a definition of the original video meets a specific standard or requirement, for example, the original video is a high-definition video. The boundary detection refers to a process of performing detection and positioning on a boundary between different scenes in a video, aiming to determine a place where a scene change occurs in the video, and is usually configured for detecting and segmenting a boundary location of a consecutive scene. The scene boundary is the boundary location of the consecutive scene in the video, that is, a location where scene switching occurs. In a video playing process, a location where a significant change and jumping occur in a video picture is a location of the scene boundary.

Specifically, the terminal obtains an authorized and reliable video website or video sharing platform, determines an original video meeting the definition condition from the video website or video sharing platform, obtains a video link of the original video, and downloads, by using a video downloading tool and based on the obtained video link, the original video meeting the definition condition from the video website or video sharing platform. After obtaining the original video, the terminal performs boundary detection on the original video based on a preset boundary detection algorithm, to obtain a scene boundary in the original video. After obtaining the scene boundary, the terminal determines a start time and an end time of each consecutive scene based on the scene boundary, extracts a video clip including the consecutive scene from the original video based on the start time and the end time, extracts a sub-video of a target length from each video clip including a consecutive scene, and uses each sub-video as a sample video. The target length is a preset length, for example, 10 frames or 30 frames.

The used downloading tool may be an Internet download manager, a free download manager, or the like. Specifically, the obtained video link may be copied and pasted to the downloading tool, and the original video corresponding to the video link is downloaded by using the downloading tool. The used boundary detection algorithm may be an inter-frame difference method, an inter-frame similarity method, a machine learning method, an optical flow method, or the like. According to the inter-frame difference method, a dynamic object and a scene change in a video are detected through comparison between different pixels of adjacent frames, to determine a scene boundary. According to the inter-frame similarity method, a change point and a scene boundary in a video are determined through calculation of a similarity and a difference between adjacent frames. According to the machine learning method, a video frame is classified and segmented by using a machine learning algorithm, such as a neural network or a support vector machine, to implement scene boundary detection. According to the optical flow method, an object motion and a scene change in a video are detected through calculation of pixel displacement and a pixel change between adjacent frames, to determine a scene boundary.

In an embodiment, the terminal detects a scene boundary in an original video by using a scene detection tool, obtains a start time and an end time of each scene, and extracts, according to the scene boundary and scene time information, a video clip including a consecutive scene from the original video as a sample video. The scene detection tool may be specifically a scene detect tool. The scene detect is a Python-based video processing tool, and is mainly configured to detect and segment a scene boundary in a video. The scene detect tool can automatically identify a scene switching point in the video, including special effect switching, a scene change, picture darkening, and the like, and segment the video into consecutive scene clips.

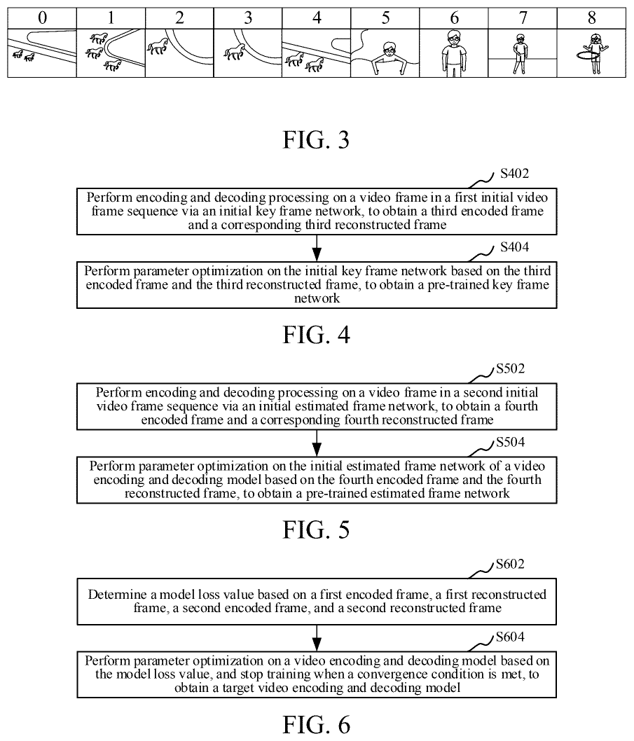

FIG. 3 shows nine consecutive frames of pictures of a video clip. A video frame 0 to a video frame 4 are pictures of a horse racing scene, and a video frame 5 to a video frame 8 are pictures of a motion scene. It may be detected by using the scene detect tool that, a scene boundary of the video clip is a time point at which the video frame 4 ends and the video frame 5 starts. The video clip is segmented at the time point, to obtain a sample video 1 and a sample video 2. The sample video 1 includes a consecutive scene clip including the video frame 0 to the video frame 4, and the sample video 2 includes a consecutive scene clip including the video frame 5 to the video frame 8.

In the foregoing embodiments, the terminal obtains the original video meeting the definition condition and performs boundary detection on the original video, to obtain the scene boundary in the original video, and extracts, based on the scene boundary, the video clip including the consecutive scene from the original video as the sample video, so that the sample video has higher quality in aspects of a definition, continuity, and stability, thereby improving a training effect of a model when the sample video is configured for training the video encoding and decoding model.

In an embodiment, a process in which the terminal extracts, based on the scene boundary, the video clip including the consecutive scene from the original video as the sample video specifically includes the following operations: extracting, based on the scene boundary, the video clip including the consecutive scene from the original video; and performing artifact removal processing on the video clip, to obtain the sample video.

The artifact removal processing refers to a process of adjusting parameters such as a color, contrast, and acuteness of a video and removing an artifact and a noise in the video, to improve quality and a definition of the video.

Specifically, after obtaining the video clip, the terminal extracts the sub-video of the target length from each video clip including consecutive scenes, and performs artifact removal processing on each video frame in the sub-video by using a preset artifact removal algorithm, to obtain the sample video.

The preset artifact removal algorithm may be artifacts removal. The artifacts removal is a video processing technology, aiming to remove factors affecting video quality, such as an artifact, a noise, and distortion in a video, and improve a definition and quality of the video. The artifact generally refers to any distortion or abnormality in a non-original scene in an image or a video caused by data compression, a transmission error, an algorithm defect in a processing process, and the like. The artifact may be in a form of a block noise, blurring, banding, mosaic, and the like, reducing visual quality of the video.

In the foregoing embodiments, the terminal extracts, based on the scene boundary, the video clip including the consecutive scene from the original video; and performs artifact removal processing on the video clip, to obtain the sample video whose definition and quality are ensured, to avoid training a model by using a low-quality video sample, so as to improve accuracy and robustness of the video encoding and decoding model, and further improve video encoding and decoding efficiency and visual quality.

In an embodiment, the pre-trained key frame network of the video encoding and decoding model is obtained through training of an initial key frame network. Before training the video encoding and decoding model, the terminal may further separately pre-train the key frame network of the video encoding and decoding model, to obtain the pre-trained key frame network of the video encoding and decoding model. In other words, before performing encoding and decoding processing on the key frame via the pre-trained key frame network of the video encoding and decoding model, the terminal separately pre-trains the key frame network of the video encoding and decoding model, to obtain the pre-trained key frame network of the video encoding and decoding model. Referring to FIG. 4, the process of training the initial key frame network specifically includes the following operations.

S402: Perform encoding and decoding processing on a video frame in a first initial video frame sequence via the initial key frame network, to obtain a third encoded frame and a corresponding third reconstructed frame.

The first initial video frame sequence is extracted from a first initial sample video. The first initial sample video may be a video that is the same as the sample video, or may be a video that is different from the sample video.

Specifically, the terminal may extract the first initial video frame sequence from the first initial sample video, sequentially input each video frame in the first initial video frame sequence to the initial key frame network, perform encoding processing on the inputted video frame by using an encoder of the initial key frame network, to obtain the third encoded frame, and perform decoding processing on the third encoded frame by using a decoder of the initial key frame network, to obtain the third reconstructed frame corresponding to the inputted video frame.

S404: Perform parameter optimization on the initial key frame network based on the third encoded frame and the third reconstructed frame, to obtain the pre-trained key frame network.

In an embodiment, S404 specifically includes the following operations: determining a first pre-training loss value based on the third encoded frame and the third reconstructed frame; and performing parameter optimization on the initial key frame network based on the first pre-training loss value, to obtain the pre-trained key frame network.

The first pre-training loss value is an indicator configured for measuring a compression bit rate of a video frame and a difference between the third reconstructed frame and the original video frame. The indicator may be configured for evaluating a compression effect of the initial key frame network on the video frame, and the parameter of the initial key frame network is further adjusted, to improve the compression effect of the initial key frame network on the video frame.

Specifically, after obtaining the third encoded frame and the third reconstructed frame, the terminal may further determine a byte stream size of the third reconstructed frame, determine a first video frame compression loss value based on a byte stream size of the third encoded frame, determine a first video frame reconstruction loss value based on the third reconstructed frame and the original video frame, determine the first pre-training loss value based on the first video frame compression loss value and the first video frame reconstruction loss value, adjust the network parameter of the initial key frame network based on the first pre-training loss value by using a back propagation algorithm, to obtain an adjusted initial key frame network, perform operation S402 again, and stop training when the training meets a convergence condition, to obtain the pre-trained key frame network.

The first video frame compression loss value reflects a degree of information loss of the third encoded frame in a video compression process, and may be specifically determined based on at least one of a byte stream size of an original frame and a byte stream size of a compressed frame. The first video frame reconstruction loss value reflects a degree of difference between the reconstructed third encoded frame and the original third encoded frame, and may be specifically determined through evaluation of a pixel-level difference between the reconstructed frame and the original frame.

In an embodiment, after obtaining the first video frame compression loss value and the first video frame reconstruction loss value, the terminal inputs the first video frame compression loss value and the first video frame reconstruction loss value to a loss function expressed by using the following formula, and determines the first pre-training loss value by using the following formula:

$${Loss}_{I} = {mse\_loss}_{I} + {bpp\_loss}_{I}$$

Loss_{I} is a first pre-training loss value corresponding to a video frame, mse_loss_{I} is a first video frame reconstruction loss value corresponding to the video frame, and bpp _loss_{I} is a first video frame compression loss value corresponding to the video frame. The first video frame compression loss value may be specifically the byte stream size of the third encoded frame.

In the foregoing embodiments, the terminal performs encoding and decoding processing on the video frame in the first initial video frame sequence via the initial key frame network, to obtain the third encoded frame and the corresponding third reconstructed frame, and performs parameter optimization on the initial key frame network based on the third encoded frame and the third reconstructed frame, so that key information in a video is more accurately captured through the parameter of the network, and the pre-trained key frame network is obtained. The pre-trained key frame network may be used as a basic model for a subsequent task, to accelerate a training process of the subsequent task and improve model performance.

In an embodiment, the pre-trained estimated frame network of the video encoding and decoding model is obtained through training of an initial estimated frame network. Before training the video encoding and decoding model, the terminal may further separately pre-train the estimated frame network of the video encoding and decoding model, to obtain the pre-trained estimated frame network of the video encoding and decoding model. In other words, before performing encoding and decoding processing on the estimated frame via the pre-trained estimated frame network of the video encoding and decoding model, the terminal separately pre-trains the estimated frame network of the video encoding and decoding model, to obtain the pre-trained estimated frame network of the video encoding and decoding model. Referring to FIG. 5, the process of training the initial estimated frame network specifically includes the following operations.

S502: Perform encoding and decoding processing on a video frame in a second initial video frame sequence via the initial estimated frame network, to obtain a fourth encoded frame and a corresponding fourth reconstructed frame.

The second initial video frame sequence is extracted from a second initial sample video. The second initial sample video may be a video that is the same as the sample video, or may be a video that is different from the sample video. The second initial sample video may be the same as or different from the first initial sample video.

Specifically, the terminal may extract the second initial video frame sequence from the second initial sample video, sequentially input each video frame in the second initial video frame sequence to the initial estimated frame network, perform encoding processing on the inputted video frame by using an encoder of the initial estimated frame network, to obtain the fourth encoded frame, and perform decoding processing on the fourth encoded frame by using a decoder of the initial estimated frame network, to obtain the fourth reconstructed frame corresponding to the inputted video frame.

S504: Perform parameter optimization on the initial estimated frame network of the video encoding and decoding model based on the fourth encoded frame and the fourth reconstructed frame, to obtain the pre-trained estimated frame network.

In an embodiment, S504 specifically includes the following operations: determining a second pre-training loss value based on the fourth encoded frame and the fourth reconstructed frame; and performing parameter optimization on the initial estimated frame network based on the second pre-training loss value, to obtain the pre-trained estimated frame network.

The second pre-training loss value is an indicator configured for measuring a compression bit rate of a video frame and a difference between the fourth reconstructed frame and the original video frame. The indicator may be configured for evaluating a compression effect of the initial estimated frame network on the video frame, and the parameter of the initial estimated frame network is further adjusted, to improve the compression effect of the initial estimated frame network on the video frame.

Specifically, after obtaining the fourth encoded frame and the fourth reconstructed frame, the terminal may further determine a byte stream size of the fourth reconstructed frame, determine a second video frame compression loss value based on a byte stream size of the fourth encoded frame, determine a second video frame reconstruction loss value based on the fourth reconstructed frame and the original video frame, determine the second pre-training loss value based on the second video frame compression loss value and the second video frame reconstruction loss value, adjust the network parameter of the initial estimated frame network based on the second pre-training loss value by using the back propagation algorithm, to obtain an adjusted initial estimated frame network, perform operation S502 again, and stop training when the training meets a convergence condition, to obtain the pre-trained estimated frame network.

The second video frame compression loss value reflects a degree of information loss of the fourth encoded frame in a video compression process, and may be specifically determined based on at least one of a byte stream size of an original frame and a byte stream size of a compressed frame. The second video frame reconstruction loss value reflects a degree of difference between the reconstructed fourth encoded frame and the original fourth encoded frame, and may be specifically determined through evaluation of a pixel-level difference between the reconstructed frame and the original frame.

In an embodiment, after obtaining the second video frame compression loss value and the second video frame reconstruction loss value, the terminal inputs the second video frame compression loss value and the second video frame reconstruction loss value to a loss function expressed by the following formula, and determines the second pre-training loss value by using the following formula:

$${Loss}_{P} = {mse\_loss}_{P} + {bpp\_loss}_{P}$$

Loss_{P} is a second pre-training loss value corresponding to a video frame, mse_loss_{P} is a second video frame reconstruction loss value corresponding to the video frame, and bpp_loss_{P} is a second video frame compression loss value corresponding to the video frame. The second video frame compression loss value may be specifically the byte stream size of the fourth encoded frame.

In the foregoing embodiments, the terminal performs encoding and decoding processing on the video frame in the second initial video frame sequence via the initial estimated frame network, to obtain the fourth encoded frame and the corresponding fourth reconstructed frame, and performs parameter optimization on the initial estimated frame network based on the fourth encoded frame and the fourth reconstructed frame, so that key information in a video is more accurately captured through the parameter of the network, and the pre-trained estimated frame network is obtained. The pre-trained estimated frame network may be used as a basic model for a subsequent task, to accelerate a training process of the subsequent task and improve model performance.

In an embodiment, the pre-trained key frame network of the video encoding and decoding model includes an encoder and a decoder. A process in which the terminal performs encoding and decoding processing on the key frame via the pre-trained key frame network of the video encoding and decoding model, to obtain the first encoded frame and the corresponding first reconstructed frame specifically includes the following operations: performing encoding processing on the key frame by using the encoder, to obtain the first encoded frame; and performing decoding processing on the first encoded frame by using the decoder, to obtain the first reconstructed frame.

Encoding is a process of compressing a video signal into a smaller data volume for ease of storage, transmission, and processing. The encoder processes and compresses an original video frame, to generate a series of encoded data. The data may be transmitted or stored, so that the data may be decoded into the original video frame when needed.

The decoder is configured to decode a bitstream obtained through compression and restore the bitstream to an image frame. Image quality of the restored image frame may be different from image quality of an original frame because in a compression encoding process, a part of information about the original frame is compressed, and the decoder needs to restore the part of information by using a technology such as estimation in a decoding process. Therefore, the image quality of the restored image frame is usually lower than that of the original frame. However, a proper compression ratio is used, so that video transmission and storage costs can be reduced while video quality is ensured.

Specifically, the terminal inputs the key frame in the video frame sequence to the encoder of the pre-trained key frame network, performs partitioning processing on the key frame by using the encoder of the pre-trained key frame network, to obtain key frame image blocks, and performs compression processing on the key frame image blocks, to obtain the first encoded frame. The first encoded frame is a compressed bitstream. Then, the terminal inputs the first encoded frame to the decoder of the pre-trained key frame network, decodes the first encoded frame, that is, the compressed bitstream, by using the decoder, to obtain a decoding result, restores the image blocks based on the decoding result, to obtain the restored image blocks, and splices the restored image blocks, to obtain a restored image corresponding to the key frame. The restored image is the first reconstructed frame.

In the foregoing embodiments, the terminal performs encoding processing on the key frame by using the encoder to obtain the first encoded frame, and performs decoding processing on the first encoded frame by using the decoder to obtain the first reconstructed frame, so that a model loss value may be determined based on the first encoded frame and the first reconstructed frame. The model parameter is optimized, and the loss value is minimized, thereby improving an encoding and decoding effect of the video encoding and decoding model.

In an embodiment, the pre-trained estimated frame network of the video encoding and decoding model includes an encoder and a decoder, and a process in which the terminal performs encoding and decoding processing on the estimated frame via the pre-trained estimated frame network of the video encoding and decoding model, to obtain the second encoded frame and the corresponding second reconstructed frame specifically includes the following operations: performing encoding processing on the estimated frame by using the encoder, to obtain the second encoded frame; and performing decoding processing on the second encoded frame by using the decoder, to obtain the second reconstructed frame.

Specifically, the terminal inputs a to-be-processed estimated frame in a video frame sequence and a reference frame corresponding to the estimated frame to the encoder of the pre-trained estimated frame network, performs motion estimation and motion compensation on the reference frame and the estimated frame by using the encoder of the pre-trained estimated frame network, to obtain a difference frame, and compresses and encodes the difference frame, to obtain the second encoded frame. The second encoded frame is a compressed bitstream. Then, the terminal inputs the second encoded frame to the decoder of the pre-trained estimated frame network, decodes the second encoded frame, that is, the compressed bitstream, by using the decoder, to obtain a decoding result, restores pixel information of the difference frame based on the decoding result, and performs motion compensation on the difference frame based on a restored image obtained through restoration of the reference frame, to obtain a restored image corresponding to the estimated frame. The restored image is the second reconstructed frame.

The reference frame may be a reconstructed frame corresponding to a previous video frame of the current to-be-processed estimated frame. For example, if the to-be-processed estimated frame is a 1^{st} estimated frame in the video frame sequence (namely, a 2^{nd} video frame in the video frame sequence), the reference frame of the to-be-processed estimated frame is a reconstructed frame corresponding to the key frame (namely, a reconstructed frame corresponding to a 1^{st} video frame in the video frame sequence). If the to-be-processed estimated frame is a 2^{nd} estimated frame in the video frame sequence (namely, a 3^{rd} video frame in the video frame sequence), the reference frame of the to-be-processed estimated frame is a reconstructed frame corresponding to the 1^{st} estimated frame in the video frame sequence (namely, a reconstructed frame corresponding to the 2^{nd} video frame in the video frame sequence).

In the foregoing embodiments, the terminal performs encoding processing on the key frame by using the encoder to obtain the second encoded frame, and performs decoding processing on the second encoded frame by using the decoder to obtain the second reconstructed frame, so that a model loss value may be determined based on the second encoded frame and the second reconstructed frame. The model parameter is optimized and the loss value is minimized, thereby improving an encoding and decoding effect of the video encoding and decoding model.

In an embodiment, as shown in FIG. 6, a process in which the terminal performs model optimization on the video encoding and decoding model based on the first encoded frame, the first reconstructed frame, the second encoded frame, and the second reconstructed frame, to obtain the target video encoding and decoding model includes the following operations.

S602: Determine a model loss value based on the first encoded frame, the first reconstructed frame, the second encoded frame, and the second reconstructed frame.

The model loss value is an indicator for measuring a compression bit rate of a video frame and a difference between a reconstructed frame and an original frame. The indicator may be configured for evaluating a compression effect of the video encoding and decoding model on the video frame, and the parameter of the video encoding and decoding model is further adjusted, to improve the compression effect of the video encoding and decoding model on the video frame.

Specifically, after obtaining the first encoded frame, the first reconstructed frame, the second encoded frame, and the second reconstructed frame, the terminal determines the model loss value based on a byte stream size of the first encoded frame, the first reconstructed frame, a byte stream size of the second encoded frame, and the second reconstructed frame.

The byte stream size of the first encoded frame is configured for representing a compression bit rate of the first encoded frame, and the byte stream size of the second encoded frame is configured for representing a compression bit rate of the second encoded frame.

S604: Perform parameter optimization on the video encoding and decoding model based on the model loss value, and stop training when a convergence condition is met, to obtain the target video encoding and decoding model.

Convergence means that a training process of a model already tends to be stable, that is, the video encoding and decoding model has learned a feature of data, and there is no significant improvement. The convergence condition includes a fixed quantity of training rounds, a fixed threshold of a loss function, and the like. When the model meets the condition, training is stopped, so that overfitting is avoided.

Specifically, after obtaining the model loss value, the terminal adjusts a weight parameter value and a bias parameter value of the video encoding and decoding model by using the back propagation algorithm, to obtain an adjusted video encoding and decoding model, performs operation S602 again, and stops training when the training meets the convergence condition, to obtain the target video encoding and decoding model.

In the foregoing embodiments, the terminal determines the model loss value based on the first encoded frame, the first reconstructed frame, the second encoded frame, and the second reconstructed frame, performs parameter optimization on the video encoding and decoding model based on the model loss value, and stops training when the convergence condition is met. Through continuous optimization of the model parameter, the target video encoding and decoding model obtained through training can more accurately encode and decode video data, thereby improving an encoding and decoding effect of the target video encoding and decoding model.

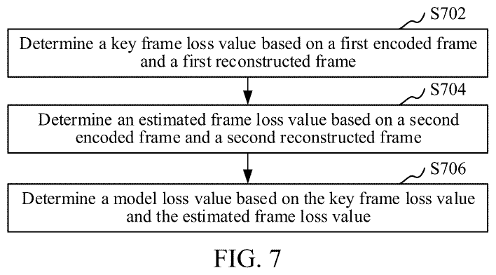

In an embodiment, as shown in FIG. 7, a process in which the terminal determines the model loss value based on the first encoded frame, the first reconstructed frame, the second encoded frame, and the second reconstructed frame specifically includes the following operations.

S702: Determine a key frame loss value based on the first encoded frame and the first reconstructed frame.

The key frame loss value is an indicator configured for measuring a compression bit rate of the key frame and a difference between the first reconstructed frame and the original key frame. The indicator may be configured for evaluating a compression effect of the pre-trained key frame network of the video encoding and decoding model on the key frame, and the parameter of the video encoding and decoding model is further adjusted, to improve the compression effect of the video encoding and decoding model on the video frame.

Specifically, after obtaining the first encoded frame and the first reconstructed frame, the terminal may further determine the byte stream size of the first encoded frame, determine a key frame compression loss value based on the byte stream size of the first encoded frame, determine a key frame reconstruction loss value based on the first reconstructed frame and the key frame, and then determine the key frame loss value based on the key frame compression loss value and the key frame reconstruction loss value.

The key frame compression loss value reflects a degree of information loss of the key frame in a video compression process, and may be specifically determined based on at least one of a byte stream size of an original frame and a byte stream size of a compressed frame. The key frame reconstruction loss value reflects a degree of difference between the reconstructed key frame and the original key frame, and may be specifically determined through evaluation of a pixel level difference between the reconstructed frame and the original frame.

In an embodiment, after obtaining the key frame compression loss value and the key frame reconstruction loss value, the terminal inputs the key frame compression loss value and the key frame reconstruction loss value to a loss function expressed by the following formula, and determines the key frame loss value by using the following formula:

$${Loss}_{i} = {mse\_loss}_{i} + {bpp\_loss}_{i}$$

Lossᵢ is a key frame loss value corresponding to a key frame, mse_lossᵢ is a key frame reconstruction loss value corresponding to the key frame, bpp_lossᵢ is a key frame compression loss value corresponding to the key frame, and the key frame compression loss value may be specifically the byte stream size of the first encoded frame.

S704: Determine an estimated frame loss value based on the second encoded frame and the second reconstructed frame.

The estimated frame loss value is an indicator configured for measuring a compression bit rate of the estimated frame and a difference between the first reconstructed frame and the original estimated frame. The indicator may be configured for evaluating a compression effect of the pre-trained estimated frame network of the video encoding and decoding model on the estimated frame, and the parameter of the video encoding and decoding model is further adjusted, to improve the compression effect of the video encoding and decoding model on the video frame.

Specifically, after obtaining the second encoded frame and the second reconstructed frame, the terminal may further determine the byte stream size of the second encoded frame, determine an estimated frame compression loss value based on the byte stream size of the second encoded frame, determine an estimated frame reconstruction loss value based on the second reconstructed frame and the estimated frame, and then determine the estimated frame loss value based on the estimated frame compression loss value and the estimated frame reconstruction loss value.

In an embodiment, after obtaining the estimated frame compression loss value and the estimated frame reconstruction loss value, the terminal inputs the estimated frame compression loss value and the estimated frame reconstruction loss value to a loss function expressed by the following formula, and determines the estimated frame loss value by using the following formula:

$${Loss}_{p} = {mse\_loss}_{p} + {bpp\_loss}_{p}$$

Lossₚ is an estimated frame loss value corresponding to any estimated frame, mse_lossₚ is an estimated frame reconstruction loss value corresponding to any estimated frame, bpp_lossₚ is an estimated frame compression loss value corresponding to any estimated frame, and the estimated frame compression loss value may be specifically the byte stream size of the second encoded frame.

S706: Determine the model loss value based on the key frame loss value and the estimated frame loss value.

Specifically, after obtaining the key frame loss value and the estimated frame loss value, the terminal obtains a preset loss function, inputs the key frame loss value and the estimated frame loss value to the preset loss function, and determines the model loss value based on the preset loss function.

In an embodiment, after obtaining the key frame loss value and the estimated frame loss value, the terminal inputs the key frame loss value and the estimated frame loss value to a loss function expressed by the following formula, and determines the model loss value by using the following formula:

$$Loss = {Loss}_{i} + \text{?} Los \text{?}$$

$$\text{?} \text{indicates text missing or illegible when filed}$$

Lossᵢ is a key frame loss value corresponding to a key frame (a 1^{st} frame in the video frame sequence), Lossₚⁱ is an estimated frame loss value corresponding to a (j−1)^{th} estimated frame (a j^{th} frame in the video frame sequence), there are a total of n frames in the video frame sequence, and Loss is a model loss value determined based on the n video frames in the video frame sequence.

In an embodiment, after obtaining the key frame loss value and the estimated frame loss value, the terminal may further obtain a first loss weight corresponding to the key frame loss value and a second loss weight corresponding to the estimated frame loss value, and determine the model loss value based on the first loss weight, the key frame loss value, the second loss weight, and the estimated frame loss value.

In the foregoing embodiments, the terminal determines the key frame loss value based on the first encoded frame and the first reconstructed frame, determines the estimated frame loss value based on the second encoded frame and the second reconstructed frame, and determines the model loss value based on the key frame loss value and the estimated frame loss value, to perform joint training on the pre-trained key frame network and the pre-trained estimated frame network of the video encoding and decoding model based on the model loss value. The model parameter is continuously optimized, and the target video encoding and decoding model obtained through training can more accurately encode and decode video data, thereby improving an encoding and decoding effect of the target video encoding and decoding model.

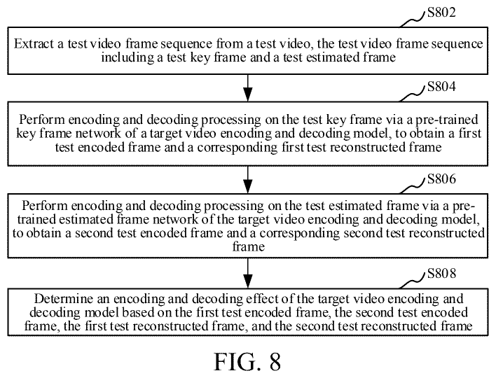

In an embodiment, as shown in FIG. 8, the foregoing video encoding and decoding processing method further includes a testing process of testing the trained target video encoding and decoding model. The testing process specifically includes the following operations.

S802: Extract a test video frame sequence from a test video, the test video frame sequence including a test key frame and a test estimated frame.

The test video is video data configured for testing performance of the target video encoding and decoding model. The test video includes video frame sequences of various types such as different resolution, different encoding quality, and different scenes, to comprehensively evaluate encoding and decoding effects of the model in different cases.

Specifically, after obtaining the test video, the terminal extracts the test video frame sequence from the test video according to a specific time interval, determines a 1^{st} frame in the test video frame sequence as the test key frame, and determines a video frame other than the 1^{st} frame in the test video frame sequence as the test estimated frames.

S804: Perform encoding and decoding processing on the test key frame via a pre-trained key frame network of the target video encoding and decoding model, to obtain a first test encoded frame and a corresponding first test reconstructed frame.

Specifically, after obtaining the test video frame sequence, the terminal inputs the test key frame in the test video frame sequence to the pre-trained key frame network of the target video encoding and decoding model, and performs encoding and decoding processing on the test key frame via the pre-trained key frame network, to obtain the first test encoded frame corresponding to the test key frame and the first test reconstructed frame corresponding to the first test encoded frame.

S806: Perform encoding and decoding processing on the test estimated frame via a pre-trained estimated frame network of the target video encoding and decoding model, to obtain a second test encoded frame and a corresponding second test reconstructed frame.

Specifically, after obtaining the test video frame sequence, the terminal inputs the test estimated frame in the test video frame sequence to the pre-trained estimated frame network of the target video encoding and decoding model, and performs encoding and decoding processing on the test estimated frame via the pre-trained estimated frame network, to obtain the second test encoded frame corresponding to the test estimated frame and the second test reconstructed frame corresponding to the second test encoded frame.

S808: Determine an encoding and decoding effect of the target video encoding and decoding model based on the first test encoded frame, the second test encoded frame, the first test reconstructed frame, and the second test reconstructed frame.

Specifically, after obtaining the first test encoded frame, the second test encoded frame, the first test reconstructed frame, and the second test reconstructed frame, the terminal determines a compression evaluation result of the target video encoding and decoding model based on the first test encoded frame and the second test encoded frame, determines a reconstruction evaluation result of the target video encoding and decoding model based on the first test reconstructed frame and the second test reconstructed frame, and determines the encoding and decoding effect of the target video encoding and decoding model based on the compression evaluation result and the reconstruction evaluation result.

The compression evaluation result includes a size (bpp) of a compressed byte stream. Bits per pixel (bpp) are a video encoding efficiency indicator, and indicates a quantity of bits required for each pixel. A lower bpp value indicates higher video encoding efficiency, that is, a smaller quantity of bits required for same visual quality.

In an embodiment, after obtaining the first test encoded frame and the second test encoded frame, the terminal determines a size of a compressed byte stream of the first test encoded frame and a size of a compressed byte stream of the second test encoded frame respectively, determines a size of a compressed byte stream of the test video frame sequence based on the size of the compressed byte stream of the first test encoded frame and the size of the compressed byte stream of the second test encoded frame, and determines the size of the compressed byte stream of the test video frame sequence as the compression evaluation result of the target video encoding and decoding model.

The reconstruction evaluation result includes quality (peak signal-to-noise ratio, PSNR) of a reconstructed image. A PSNR is a video quality evaluation indicator, and is configured for comparison of a similarity between an original video frame image and a video frame image after encoding and decoding. A higher PSNR value indicates better quality of a reconstructed video, that is, a better encoding and decoding effect.

Specifically, after obtaining the first test reconstructed frame and the second test reconstructed frame, the terminal determines quality of a reconstructed image of the first test reconstructed frame based on the first test reconstructed frame and the test key frame, determines quality of a reconstructed image of the second test reconstructed frame based on the second test reconstructed frame and the test estimated frame, determines quality of a reconstructed image of the test video frame sequence according to the quality of the reconstructed image of the first test reconstructed frame and the quality of the reconstructed image of the second test reconstructed frame, and determines the quality of the reconstructed image of the test video frame sequence as the reconstruction evaluation result of the target video encoding and decoding model.

In an embodiment, after obtaining the compression evaluation result and the reconstruction evaluation result of the target video encoding and decoding model, the terminal generates a reconstruction evaluation score based on the compression evaluation result and the reconstruction evaluation result. The reconstruction evaluation score is the reconstruction evaluation result.

The following Table 1 shows a reconstruction evaluation result of a conventional video encoding and decoding model trained by using a conventional solution and a reconstruction evaluation result of the target video encoding and decoding model trained by using the solution of this application. It can be learned from the table that, for encoding and decoding of an I frame, a P0 frame, a P1 frame, and a P2 frame, reconstruction evaluation scores of the conventional video encoding and decoding model are respectively 80, 70, 70, and 70, and an overall reconstruction evaluation score is 72.5. Reconstruction evaluation scores of the target video encoding and decoding model are respectively 75, 75, 75, and 75, and an overall reconstruction evaluation score is 75. Therefore, the reconstruction evaluation result of the target video encoding and decoding model is better on the whole.

TABLE 1

| Training | | | | | Reconstruction |
|---|---|---|---|---|---|
| mode | I | P0 | P1 | P2 | evaluation result |
| Conventional | 80 | 70 | 70 | 70 | 72.5 |
| solution | | | | | |
| Solution of this | 75 | 75 | 75 | 75 | 75 |
| application | | | | | |

In an embodiment, after obtaining the compression evaluation result and the reconstruction evaluation result, the terminal generates a reconstruction evaluation diagram based on the compression evaluation result and the reconstruction evaluation result, and determines the reconstruction evaluation result of the target video encoding and decoding model based on the reconstruction evaluation diagram.

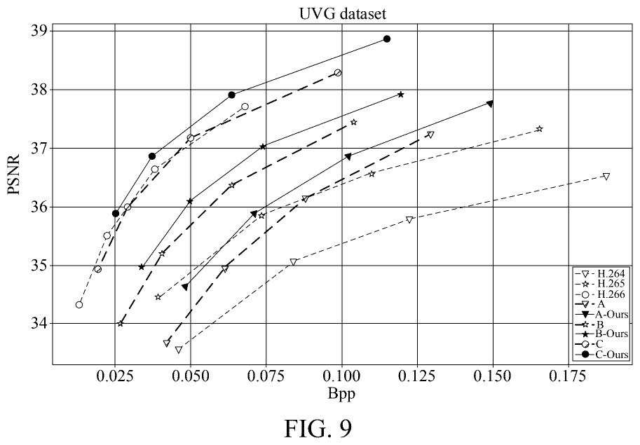

FIG. 9 shows reconstruction evaluation results obtained through processing of a test video by using different video encoding and decoding models. The test video is an ultra video group (UVG) dataset, and the UVG dataset is a video quality evaluation dataset and is provided by the University of Texas at Austin. The dataset includes 20 720p videos of different themes and content, and each video includes five versions at different compression levels, and there are a total of 100 videos. In FIG. 9, a horizontal coordinate represents bpp, a vertical coordinate represents PSNR, and H264, H265, and H266 represent three generations of typical and conventional encoding and decoding technologies for reference. A, B, and C respectively represent conventional video encoding and decoding models (machine learning models) obtained through training of initial models of different structures by using the conventional solution, and A-ours, B-ours, and C-ours respectively represent target video encoding and decoding models obtained through training of the initial models of different structures by using the solution of this application. It can be learned from the diagram that, a reconstruction evaluation result of a target video encoding and decoding model obtained through training by using the solution of this application is better than a reconstruction evaluation result of a corresponding conventional video encoding and decoding model and a corresponding conventional encoding and decoding technology.

In the foregoing embodiments, the terminal extracts the test video frame sequence from the test video, the test video frame sequence including the test key frame and the test estimated frame. The terminal performs encoding and decoding processing on the test key frame via the pre-trained key frame network of the target video encoding and decoding model, to obtain the first test encoded frame and the corresponding first test reconstructed frame, performs encoding and decoding processing on the test estimated frame via the pre-trained estimated frame network of the target video encoding decoding model, to obtain the second test encoded frame and the corresponding second test reconstructed frame, and determines the encoding and decoding effect of the target video encoding and decoding model on new data based on the first test encoded frame, the second test encoded frame, the first test reconstructed frame, and the second test reconstructed frame, to evaluate performance of the model in an actual application scenario, and find a problem of the model in time and perform adjustment and optimization, thereby improving a generalization capability and practicability of the model. In addition, reliable support may be provided, through testing, for application of the model, thereby improving reliability of the application of the model.

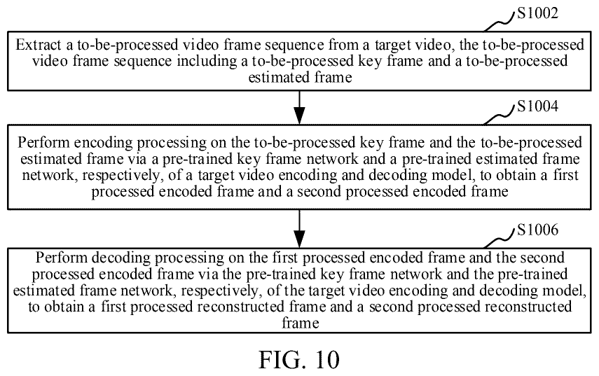

In an embodiment, as shown in FIG. 10, a process in which the terminal performs encoding and decoding processing on the target video by using the target video encoding and decoding model specifically includes the following operations.

S1002: Extract a to-be-processed video frame sequence from the target video, the to-be-processed video frame sequence including a to-be-processed key frame and a to-be-processed estimated frame. The to-be-processed video frame sequence, the to-be-processed key frame, and the to-be-processed estimated frame are also referred to as a “target video frame sequence,” a “target key frame,” and a “Target estimated frame,” respectively.

Specifically, the terminal may be a transmitting end or a receiving end. After obtaining the target video, the transmitting end extracts the to-be-processed video frame sequence from the target video according to a specific time interval, determines a 1^{st} frame in the to-be-processed video frame sequence as the to-be-processed key frame, and determines a video frame other than the 1^{st} frame in the to-be-processed video frame sequence as the to-be-processed estimated frame.

S1004: Perform encoding processing on the to-be-processed key frame and the to-be-processed estimated frame via a pre-trained key frame network and a pre-trained estimated frame network, respectively, of the target video encoding and decoding model, to obtain a first processed encoded frame and a second processed encoded frame.

Specifically, after obtaining the to-be-processed video frame sequence, the terminal inputs the to-be-processed key frame in the to-be-processed video frame sequence to the pre-trained key frame network of the target video encoding and decoding model, and performs encoding processing on the to-be-processed key frame by using an encoder of the pre-trained key frame network, to obtain the first processed encoded frame corresponding to the to-be-processed key frame; and the terminal inputs the to-be-processed estimated frame in the to-be-processed video frame sequence to the pre-trained estimated frame network of the target video encoding and decoding model, and performs encoding processing on the to-be-processed estimated frame by using an encoder of the pre-trained estimated frame network, to obtain the second processed encoded frame corresponding to the to-be-processed estimated frame.

In an embodiment, a process in which the terminal inputs the to-be-processed estimated frame in the to-be-processed video frame sequence to the pre-trained estimated frame network of the target video encoding and decoding model, and performs encoding processing on the to-be-processed estimated frame by using the encoder of the pre-trained estimated frame network specifically includes the following operations: inputting the to-be-processed estimated frame in the to-be-processed video frame sequence and a to-be-processed reference frame corresponding to the to-be-processed estimated frame to the pre-trained estimated frame network of the target video encoding and decoding model, performing motion estimation and motion compensation on the to-be-processed reference frame and the to-be-processed estimated frame by using the encoder of the pre-trained estimated frame network, to obtain a difference frame, and performing compression and encoding on the difference frame, to obtain the second processed encoded frame.

The to-be-processed reference frame may be a reconstructed frame corresponding to a previous video frame of the to-be-processed estimated frame. For example, if the to-be-processed estimated frame is a 1^{st} estimated frame in the to-be-processed video frame sequence (namely, a 2^{nd} video frame in the to-be-processed video frame sequence), the to-be-processed reference frame of the to-be-processed estimated frame is a reconstructed frame corresponding to the key frame in the to-be-processed video frame sequence (namely, a reconstructed frame corresponding to a 1^{st} video frame in the to-be-processed video frame sequence). If the to-be-processed estimated frame is a 2^{nd} estimated frame in the video frame sequence (namely, a 3^{rd} video frame in the video frame sequence), the to-be-processed reference frame of the to-be-processed estimated frame is a reconstructed frame corresponding to the 1^{st} estimated frame in the to-be-processed video frame sequence (namely, a reconstructed frame corresponding to the 2^{nd} video frame in the to-be-processed video frame sequence).

After obtaining a first processed encoded frame, the terminal may further input the first processed encoded frame to a decoder of the pre-trained key frame network, perform decoding processing on the first processed encoded frame by using the decoder, to obtain a first processed reconstructed frame, use the first processed reconstructed frame as a reference frame of the 1^{st} estimated frame in the to-be-processed video frame sequence, input the reference frame together with the 1^{st} estimated frame to the encoder of the pre-trained estimated frame network, perform motion estimation and motion compensation on the reference frame and the 1^{st} estimated frame by using the encoder to obtain a difference frame, perform compression and encoding on the difference frame to obtain a second processed encoded frame corresponding to the 1^{st} estimated frame, input the reference frame of the 1^{st} estimated frame and the second processed encoded frame corresponding to the 1^{st} estimated frame to a decoder of the pre-trained estimated frame network, perform decoding processing on the second processed encoded frame corresponding to the 1^{st} estimated frame by using the decoder, to obtain a decoding result, perform restoration based on the decoding result and the 1^{st} estimated frame to obtain a second processed encoded frame corresponding to the 1^{st} estimated frame, use the second processed encoded frame corresponding to the 1^{st} estimated frame as a reference frame of the 2^{nd} estimated frame in the to-be-processed video frame sequence, and so on, until a second processed encoded frame corresponding to each video frame in the to-be-processed video frame sequence is obtain.

After the to-be-processed video frame sequence is encoded, to obtain the first processed encoded frame and the second processed encoded frame, the first processed encoded frame and the second processed encoded frame are transmitted to the receiving end, so that after receiving the first processed encoded frame and the second processed encoded frame, the receiving end performs decoding processing on the first processed encoded frame and the second processed encoded frame, to obtain a restored target video.

S1006: Perform decoding processing on the first processed encoded frame and the second processed encoded frame via the pre-trained key frame network and the pre-trained estimated frame network, respectively, of the target video encoding and decoding model, to obtain a first processed reconstructed frame and a second processed reconstructed frame.

Specifically, after obtaining the first processed encoded frame and the second processed encoded frame, the terminal inputs the first processed encoded frame to the pre-trained key frame network of the target video encoding and decoding model, and performs decoding processing on the first processed encoded frame by using the decoder of the pre-trained key frame network, to obtain the first processed reconstructed frame; and the terminal inputs the second processed encoded frame to the pre-trained estimated frame network of the target video encoding and decoding model, and performs decoding processing on the second processed encoded frame by using the decoder of the pre-trained estimated frame network, to obtain the second processed reconstructed frame.

In the foregoing embodiments, the terminal performs encoding processing on the to-be-processed key frame and the to-be-processed estimated frame respectively via the pre-trained key frame network and the pre-trained estimated frame network of the target video encoding and decoding model, and may compress video data. Decoding processing is performed on encoded data, and the compressed video data can be restored to original video data, to implement video decompression, so as to effectively reduce storage and transmission costs of the video data, improve video data transmission efficiency, and maintain a high definition and good visual quality of a video.

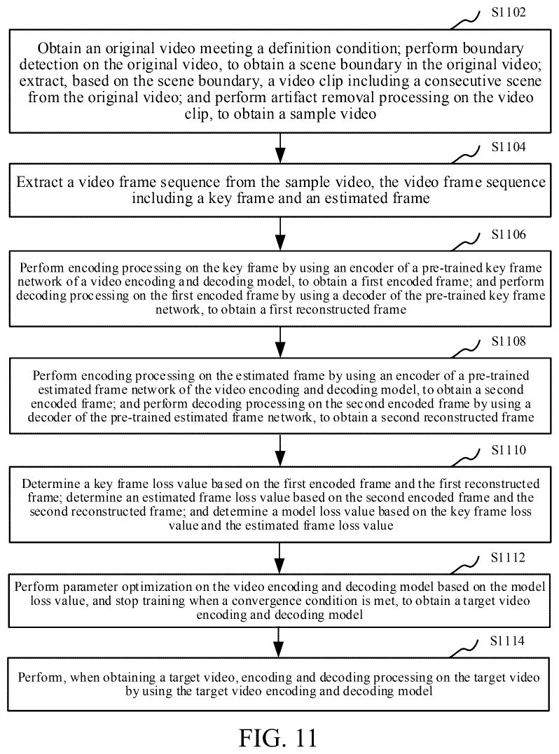

In an embodiment, as shown in FIG. 11, a video encoding and decoding processing method is further provided. An example in which the method is applied to the computer device in FIG. 1 is used for description, and the method includes the following operations.

S1102: Obtain an original video meeting a definition condition; perform boundary detection on the original video, to obtain a scene boundary in the original video; extract, based on the scene boundary, a video clip including a consecutive scene from the original video; and perform artifact removal processing on the video clip, to obtain a sample video.

S1104: Extract a video frame sequence from the sample video, the video frame sequence including a key frame and an estimated frame.

S1106: Perform encoding processing on the key frame by using an encoder of a pre-trained key frame network of a video encoding and decoding model, to obtain a first encoded frame; and perform decoding processing on the first encoded frame by using a decoder of the pre-trained key frame network of the video encoding and decoding model, to obtain a first reconstructed frame.

S1108: Perform encoding processing on the estimated frame by using an encoder of a pre-trained estimated frame network of the video encoding and decoding model, to obtain a second encoded frame; and perform decoding processing on the second encoded frame by using a decoder of the pre-trained estimated frame network, to obtain a second reconstructed frame.

S1110: Determine a key frame loss value based on the first encoded frame and the first reconstructed frame; determine an estimated frame loss value based on the second encoded frame and the second reconstructed frame; and determine a model loss value based on the key frame loss value and the estimated frame loss value.

S1112: Perform parameter optimization on the video encoding and decoding model based on the model loss value, and stop training when a convergence condition is met, to obtain a target video encoding and decoding model.

S1114: Perform, when obtaining a target video, encoding and decoding processing on the target video by using the target video encoding and decoding model.

This application further provides an application scenario. In the application scenario, the video encoding and decoding processing method is applied. Specifically, the video encoding and decoding processing method may be integrated into a software system, and a corresponding interface is provided. The interface is invoked, and encoding and decoding processing may be performed on video data by using the foregoing video encoding and decoding processing method.

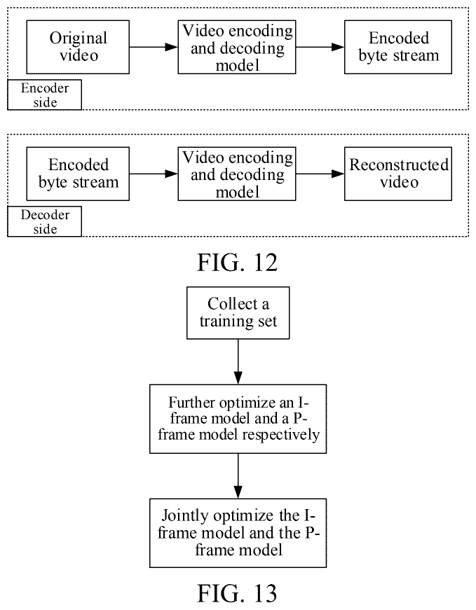

Referring to FIG. 12, the foregoing video encoding and decoding processing method may be applied to an encoder side and a decoder side. On the encoder side, a to-be-encoded video stream is inputted and an encoded byte stream is outputted, and on the decoder side, the encoded byte stream is inputted and a decoded video is outputted. The encoder side is usually a server end, and the decoder side is usually a client, so that a data volume of a transmitted video is the smallest, thereby reducing costs.

This application further provides an application scenario. The foregoing video encoding and decoding processing method is applied to the application scenario, and the video encoding and decoding method specifically includes the following operations.

### 1: Obtain Training Data

Collecting a dataset mainly includes the following operations: obtaining high-definition video links disclosed on a network; downloading high-definition videos corresponding to all the high-definition video links by using a tool; obtaining consecutive scenes in all the high-definition videos by using a scene detect tool; extracting video frames of a fixed length (10 to 30) from the consecutive scenes, where each consecutive frame of the fixed length is referred to as a clip; and performing artifacts removal on a video frame image (H, W), and further adjusting a size of the video frame image to (H×⅔, W×⅔).

In this embodiment, a total of 220,000 high-definition video scene clips or more are collected by using the foregoing policy, to provide better training data for model training.

### 2: Train a Model

Referring to FIG. 13, in a model training stage, an I-frame model (a key frame network) and a P-frame model (an estimated frame network) are trained separately first, so that the I-frame model and the P-frame model each reach an optimal state, and then joint optimization is performed on the I frame model and the P frame model, so that a video encoding and decoding indicator that is of a target video encoding and decoding model and that is obtained through combining of the I-frame model and the P-frame model together is optimal.

### a: Separately Train the I-Frame Model

For an I-frame model that has been preliminarily trained, the I-frame model is collected and trained by using collected high-definition training data. A single-frame original image is inputted, and a single-frame reconstructed image and a compressed byte stream are outputted. An I-frame model loss value is determined based on the single-frame original image, the single-frame reconstructed image, and the compressed byte stream. A parameter of the preliminarily trained I-frame model is adjusted based on the I-frame model loss value, and training is stopped when a convergence condition is met, to obtain a pre-trained I-frame model.

### b: Separately Train the P-Frame Model

For a P-frame model that has been preliminarily trained, an input image of a larger size is used for training, and a quantity n−1 of inputted consecutive frames is increased, for example, an input size is 512*512 (a size of an image used during conventional training is 256*256) and a quantity of frames for single training is 6 (a quantity of frames used for single training during conventional training is 5). For each P frame, a reconstructed frame of a previous frame of the P frame is selected as a reference frame of the P frame, consecutive P frames are inputted, and a reconstructed image and a compressed byte stream of each P frame are outputted. A P-frame model loss value is determined based on each P frame and the reconstructed image and the compressed byte stream of each P frame. A parameter of the preliminarily trained P-frame model is adjusted based on the P-frame model loss value, and training is stopped when a convergence condition is met, to obtain a pre-trained P-frame model.

### c: Perform Joint Training on the I-Frame Model and the P-Frame Model

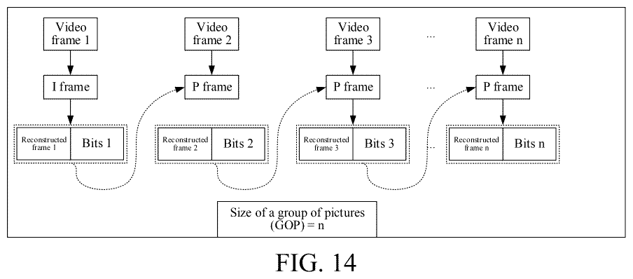

Referring to FIG. 14, the I-frame model and the P-frame model are used as a whole, a complete original GOP video frame (there are a total of n frames) is inputted, and a result obtained through encoding and decoding of n video frames by using the I-frame model and the P-frame model is outputted, including one I-frame model reconstructed image and a corresponding compressed byte stream, and (n−1) P-frame model reconstructed images and corresponding compressed byte streams. During training, n frames are inputted, and the I-frame model and the P-frame model are jointly trained as a whole. A model loss value of a video encoding and decoding model obtained through combining of the I-frame model and the P-frame model is determined based on the I-frame model reconstructed image and the corresponding compressed byte stream (bits), and the (n−1) P-frame model reconstructed images and the corresponding compressed byte streams (bits). Parameter optimization is performed on the video encoding and decoding model obtained through combining of the I-frame model and the P-frame model based on the model loss value until a convergence condition is met, to obtain a target video encoding and decoding model in which the I-frame model and the P-frame model are combined.

### 3: Model Test

To avoid a loss of an effect evaluation indicator caused by using a lossless I frame (an original I frame) as a reference frame during training of a P frame, and using a lossy I frame (a reconstructed I frame) as a reference frame during testing, in this embodiment of this application, the I-frame model and the P-frame model are used as a whole. During training, a reconstructed lossy image of a previous I frame is used as a reference frame for a 1^{st} P frame. Logic during testing is completely consistent with that during training, to avoid the loss of the effect evaluation indicator. For all subsequent P frames, logic of using a reference frame during training is also completely consistent with logic of using a reference frame during testing.

### 4: Model Application Stage

After the target video encoding and decoding model is obtained, the target video encoding and decoding model is widely applied to a scenario in which video encoding and decoding needs to be performed, for example, a scenario in which a video is transmitted, stored, or displayed, and for example, the fields of video conference, video live streaming, video monitoring, online education, and digital entertainment. Specifically, the target video encoding and decoding model may be further integrated into a software system by using the video encoding and decoding processing method. The video encoding and decoding processing method is performed to improve video transmission and storage efficiency, reduce data transmission costs and storage costs, and improve video display quality, and a corresponding interface is provided to facilitate integration and development by a developer of the software system. In addition, personalized customization may be performed according to an actual requirement, to meet requirements of different customers.

Although the operations in the flowcharts involved in the foregoing embodiments are shown sequentially as indicated by arrows, the operations are not necessarily performed sequentially as indicated by the arrows. Unless otherwise explicitly specified in this application, execution of the operations is not strictly limited, and the operations may be performed in another order. In addition, at least some of the operations in the flowcharts involved in the foregoing embodiments may include a plurality of operations or a plurality of stages. These operations or stages are not necessarily performed at the same time, but may be performed at different time. These operations or stages are not necessarily performed sequentially, but may be performed in turn or alternately with other operations or at least some operations or stages of other operations.

Based on a same inventive idea, an embodiment of this application further provides a video encoding and decoding processing apparatus configured to implement the foregoing involved video encoding and decoding processing method. An implementation solution provided by the apparatus for resolving a problem is similar to the implementation solutions recorded in the foregoing method. Therefore, for specific limitations on one or more embodiments of the video encoding and decoding processing apparatus provided below, reference may be made to the limitations on the foregoing video encoding and decoding processing method. Details are not described herein again.

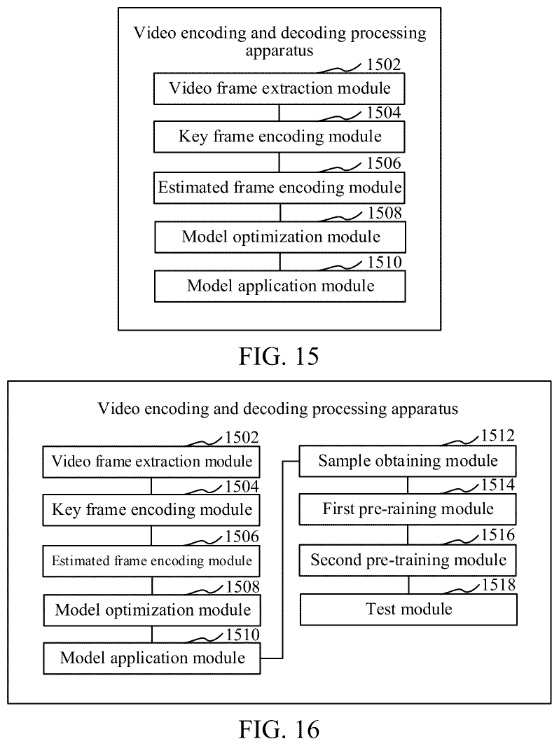

In an embodiment, as shown in FIG. 15, a video encoding and decoding processing apparatus is provided, including: a video frame extraction module 1502, a key frame encoding module 1504, an estimated frame encoding module 1506, a model optimization module 1508, and a model application module 1510.

The video frame extraction module 1502 is configured to extract a video frame sequence from a sample video, the video frame sequence including a key frame and an estimated frame.

The key frame encoding module 1504 is configured to perform encoding and decoding processing on the key frame via a pre-trained key frame network of a video encoding and decoding model, to obtain a first encoded frame and a corresponding first reconstructed frame.

The estimated frame encoding module 1506 is configured to perform encoding and decoding processing on the estimated frame via a pre-trained estimated frame network of the video encoding and decoding model, to obtain a second encoded frame and a corresponding second reconstructed frame.

The model optimization module 1508 is configured to perform model optimization on the video encoding and decoding model based on the first encoded frame, the first reconstructed frame, the second encoded frame, and the second reconstructed frame, to obtain a target video encoding and decoding model.

The model application module 1510 is configured to perform, when obtaining a target video, encoding and decoding processing on the target video by using the target video encoding and decoding model.

In the foregoing embodiment, after obtaining the video encoding and decoding model including the pre-trained key frame network and the pre-trained estimated frame network, the terminal does not directly process a video encoding and decoding task by using the video encoding and decoding model, but extracts the video frame sequence from the sample video. The video frame sequence includes the key frame and the estimated frame, so that encoding and decoding processing is performed on the key frame and the estimated frame respectively in different modes, thereby ensuring video compression quality and improving a video compression rate. Encoding and decoding processing is performed on the key frame via the pre-trained key frame network of the video encoding and decoding model, to obtain the first encoded frame and the corresponding first reconstructed frame. Encoding and decoding processing is performed on the estimated frame via the pre-trained estimated frame network of the video encoding and decoding model, to obtain the second encoded frame and the corresponding second reconstructed frame. Therefore, joint training is performed on the pre-trained key frame network and the pre-trained estimated frame network of the video encoding and decoding model based on the first encoded frame, the first reconstructed frame, the second encoded frame, and the second reconstructed frame. In other words, a parameter of the model is further optimized, the target video encoding and decoding model obtained through training has a better encoding and decoding capability for a video meeting a specific condition. For example, when the used sample video is a video meeting specific definition conditions (high definition and ultra high definition), and the target video encoding and decoding model processes an encoding and decoding task for a target video meeting the specific definition conditions (high definition and ultra high definition), video compression quality and a compression rate can be improved, that is, an encoding and decoding effect on a video is improved.

In an embodiment, as shown in FIG. 16, the apparatus further includes a sample obtaining module 1512, configured to: obtain an original video meeting a definition condition; perform boundary detection on the original video, to obtain a scene boundary in the original video; and extract, based on the scene boundary, a video clip including a consecutive scene from the original video as a sample video.

In an embodiment, the sample obtaining module 1512 is further configured to: extract, based on the scene boundary, the video clip including the consecutive scene from the original video; and perform artifact removal processing on the video clip, to obtain the sample video.

In an embodiment, the pre-trained key frame network is obtained through training of an initial key frame network. The apparatus further includes a first pre-training module 1514, configured to: perform encoding and decoding processing on a video frame in a first initial video frame sequence via the initial key frame network, to obtain a third encoded frame and a corresponding third reconstructed frame; and perform parameter optimization on the initial key frame network based on the third encoded frame and the third reconstructed frame, to obtain the pre-trained key frame network.

In an embodiment, as shown in FIG. 16, the pre-trained estimated frame network of the video encoding and decoding model is obtained through training of an initial estimated frame network. The apparatus further includes a second pre-training module 1516, configured to: perform encoding and decoding processing on a video frame in a second initial video frame sequence via the initial estimated frame network, to obtain a fourth encoded frame and a corresponding fourth reconstructed frame; and perform parameter optimization on the initial estimated frame network based on the fourth encoded frame and the fourth reconstructed frame, to obtain the pre-trained estimated frame network.

In an embodiment, the pre-trained key frame network of the video encoding and decoding model includes an encoder and a decoder. The key frame encoding module 1504 is further configured to: perform encoding processing on the key frame by using the encoder, to obtain the first encoded frame; and perform decoding processing on the first encoded frame by using the decoder, to obtain the first reconstructed frame.

In an embodiment, the pre-trained estimated frame network of the video encoding and decoding model includes an encoder and a decoder. The estimated frame encoding module 1506 is further configured to: perform encoding processing on the estimated frame by using the encoder, to obtain the second encoded frame; and perform decoding processing on the second encoded frame by using the decoder, to obtain the second reconstructed frame.

In an embodiment, the model optimization module 1508 is further configured to: determine a model loss value based on the first encoded frame, the first reconstructed frame, the second encoded frame, and the second reconstructed frame; and perform parameter optimization on the video encoding and decoding model based on the model loss value, and stop training when a convergence condition is met, to obtain the target video encoding and decoding model.

In an embodiment, the model optimization module 1508 is further configured to: determine a key frame loss value based on the first encoded frame and the first reconstructed frame; determine an estimated frame loss value based on the second encoded frame and the second reconstructed frame; and determine the model loss value based on the key frame loss value and the estimated frame loss value.

In an embodiment, as shown in FIG. 16, the apparatus further includes a test module 1518, configured to: extract a test video frame sequence from a test video, the test video frame sequence including a test key frame and a test estimated frame; perform encoding and decoding processing on the test key frame via a pre-trained key frame network of the target video encoding and decoding model, to obtain a first test encoded frame and a corresponding first test reconstructed frame; perform encoding and decoding processing on the test estimated frame via a pre-trained estimated frame network of the target video encoding and decoding model, to obtain a second test encoded frame and a corresponding second test reconstructed frame; and determine an encoding and decoding effect of the target video encoding and decoding model based on the first test encoded frame, the second test encoded frame, the first test reconstructed frame, and the second test reconstructed frame.

In an embodiment, the model application module 1510 is further configured to: extract a to-be-processed video frame sequence from the target video, the to-be-processed video frame sequence including a to-be-processed key frame and a to-be-processed estimated frame; perform encoding processing on the to-be-processed key frame and the to-be-processed estimated frame respectively via the pre-trained key frame network and the pre-trained estimated frame network of the target video encoding and decoding model, to obtain a first processed encoded frame and a second processed encoded frame; and perform decoding processing on the first processed encoded frame and the second processed encoded frame respectively via the pre-trained key frame network and the pre-trained estimated frame network of the target video encoding and decoding model, to obtain a first processed reconstructed frame and a second processed reconstructed frame.

All or a part of the modules in the foregoing video encoding and decoding processing apparatus may be implemented by software, hardware, or a combination thereof. The foregoing modules may be embedded in or independent of a processor of a computer device in a form of hardware, or may be stored in a memory of the computer device in a form of software, so that the processor invokes and performs operations corresponding to the foregoing modules.

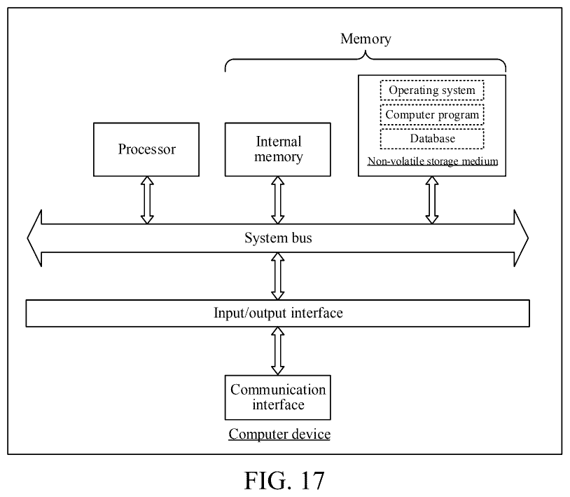

In an embodiment, a computer device is provided. The computer device may be a server, and a diagram showing an internal structure of the computer device may be shown in FIG. 17. The computer device includes a processor, a memory, an input/output (I/O for short) interface, and a communication interface. The processor, the memory, and the input/output interface are connected through a system bus, and the communication interface is connected to the system bus through the input/output interface. The processor of the computer device is configured to provide computing and controlling capabilities. The memory of the computer device includes a non-volatile storage medium and an internal memory. The non-volatile storage medium stores an operating system, computer-readable instructions, and a database. The internal memory provides an environment for running of the operating system and the computer-readable instructions that are in the non-volatile storage medium. The database of the computer device is configured to store video data. The input/output interface of the computer device is configured to exchange information between the processor and an external device. The communication interface of the computer device is configured to connect to and communicate with an external terminal via a network. When the computer-readable instructions are executed by the processor, a video encoding and decoding processing method may be implemented.

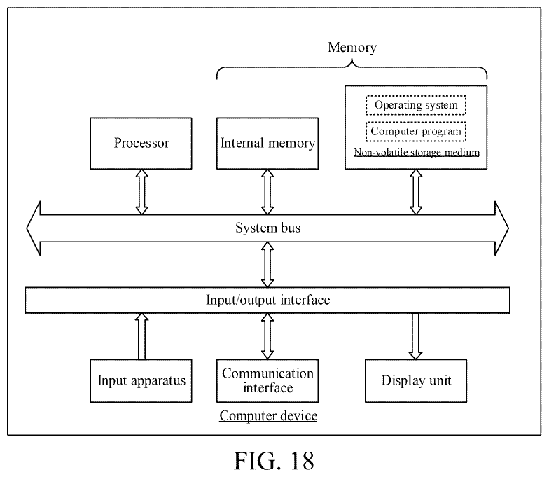

In an embodiment, a computer device is provided. The computer device may be a terminal, and a diagram showing an internal structure of the computer device may be shown in FIG. 18. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and controlling capabilities. The memory of the computer device includes a non-volatile storage medium and an internal memory. The non-volatile storage medium stores an operating system and computer-readable instructions. The internal memory provides an environment for running of the operating system and the computer-readable instructions that are in the non-volatile storage medium. The input/output interface of the computer device is configured to exchange information between the processor and an external device. The communication interface of the computer device is configured for wired or wireless communication with an external terminal. The wireless communication may be implemented through a WIFI, a mobile cellular network, near field communication (NFC), or another technology. When the computer-readable instructions are executed by the processor, a video encoding and decoding processing method may be implemented. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touchpad disposed on a housing of the computer device, or may be an external keyboard, touchpad, mouse, or the like.

A person skilled in the art may understand that the structure shown in FIG. 17 or FIG. 18 is merely a block diagram showing a part of a structure related to the solutions of this application, and does not limit the computer device to which the solutions of this application are applied. Specifically, the computer device may include more components or fewer components than those shown in the figure, include a combination of some components, or include different component layouts.

In an embodiment, a computer device is further provided, including a memory and a processor. The memory has computer-readable instructions stored therein, and the processor. When the processor executes the computer-readable instructions, the operations in the foregoing method embodiments are implemented.

In an embodiment, a computer-readable storage medium is provided. The computer-readable storage medium has computer-readable instructions stored thereon. When the computer-readable instructions are executed by a processor, the operations in the foregoing method embodiments are implemented.

In an embodiment, a computer program product is provided, including computer-readable instructions. The computer-readable instructions, when executed by a processor, implements the operations in the foregoing method embodiments.

User information (including but not limited to user equipment information, user personal information, and the like) and data (including but not limited to data for analysis, stored data, displayed data, and the like) involved in this application are both information and data authorized by a user or sufficiently authorized by all parties, and collection, use, and processing of related data need to comply with relevant laws and regulations and standards of related countries and regions.

A person of ordinary skill in the art may understand that all or some of the processes of the foregoing method embodiments may be implemented by a computer program instructing relevant hardware. The computer program may be stored in a non-volatile computer-readable storage medium. When the computer program is executed, the processes of the foregoing method embodiments are performed. Any reference to a memory, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache, or the like. For illustration without limitation, the RAM may be in various forms, for example, a static random access memory (SRAM) or a dynamic random access memory (DRAM). The database involved in the embodiments provided in this application may include at least one of a relational database and a non-relational database. The non-relational database may include a blockchain-based distributed database or the like, which is not limited thereto. The processor involved in the embodiments provided in this application may be a general purpose processor, a central processing unit, a graphic processing unit, a digital signal processor, a programmable logic unit, a quantum computation-based data processing logic device, or the like, but is not limited thereto.

The technical features in the foregoing embodiments may be combined in different modes to form other embodiments. For brevity of description, not all possible combinations of the technical features in the foregoing embodiments are described. However, the combinations of the technical features shall all be considered as falling within the scope recorded by this specification provided that no conflict exists.

The foregoing embodiments merely describe several implementations of this application and are described specifically and in detail, but cannot be understood as a limitation to the patent scope of this application. A person of ordinary skill in the art may make several changes and improvements without departing from the ideas of this application, and these changes and improvements all fall within the protection scope of this application. The protection scope of this application shall be subject to the appended claims.

What is claimed is:

1. A video encoding and decoding processing method, performed by a computer device, comprising:
extracting a video frame sequence from a sample video, the video frame sequence including a key frame and an estimated frame;
performing encoding and decoding processing on the key frame via a pre-trained key frame network of a video encoding and decoding model, to obtain a first encoded frame and a first reconstructed frame;
performing encoding and decoding processing on the estimated frame via a pre-trained estimated frame network of the video encoding and decoding model, to obtain a second encoded frame and a second reconstructed frame;
performing model optimization on the video encoding and decoding model based on the first encoded frame, the first reconstructed frame, the second encoded frame, and the second reconstructed frame, to obtain a target video encoding and decoding model; and
performing encoding and decoding processing on a target video using the target video encoding and decoding model.

2. The method according to claim 1, further comprising:
obtaining an original video meeting a definition condition;
performing boundary detection on the original video, to obtain a scene boundary in the original video;
extracting, based on the scene boundary, a video clip including a consecutive scene from the original video; and
obtaining the sample video based on the video clip.

3. The method according to claim 2, wherein obtaining the sample video based on the video clip includes:
performing artifact removal processing on the video clip, to obtain the sample video.

4. The method according to claim 1, further comprising:
performing encoding and decoding processing on a video frame in an initial video frame sequence via an initial key frame network, to obtain a third encoded frame and a third reconstructed frame; and
performing parameter optimization on the initial key frame network based on the third encoded frame and the third reconstructed frame, to obtain the pre-trained key frame network.

5. The method according to claim 1, further comprising:
performing encoding and decoding processing on a video frame in an initial video frame sequence via an initial estimated frame network, to obtain a third encoded frame and a third reconstructed frame; and
performing parameter optimization on the initial estimated frame network based on the third encoded frame and the third reconstructed frame, to obtain the pre-trained estimated frame network.

6. The method according to claim 1, wherein performing encoding and decoding processing on the key frame includes:
performing encoding processing on the key frame using an encoder in the pre-trained key frame network, to obtain the first encoded frame; and
performing decoding processing on the first encoded frame using a decoder in the pre-trained key frame network, to obtain the first reconstructed frame.

7. The method according to claim 1, wherein performing encoding and decoding processing on the estimated frame includes:
performing encoding processing on the estimated frame using an encoder in the pre-trained estimated frame network, to obtain the second encoded frame; and
performing decoding processing on the second encoded frame using a decoder in the pre-trained estimated frame network, to obtain the second reconstructed frame.

8. The method according to claim 1, wherein performing model optimization on the video encoding and decoding model includes:
determining a model loss value based on the first encoded frame, the first reconstructed frame, the second encoded frame, and the second reconstructed frame; and
performing parameter optimization on the video encoding and decoding model based on the model loss value until a convergence condition is met, to obtain the target video encoding and decoding model.

9. The method according to claim 8, wherein determining the model loss value includes:
determining a key frame loss value based on the first encoded frame and the first reconstructed frame;
determining an estimated frame loss value based on the second encoded frame and the second reconstructed frame; and
determining the model loss value based on the key frame loss value and the estimated frame loss value.

10. The method according to claim 1, further comprising:
extracting a test video frame sequence from a test video, the test video frame sequence including a test key frame and a test estimated frame;
performing encoding and decoding processing on the test key frame via a pre-trained key frame network of the target video encoding and decoding model, to obtain a first test encoded frame and a first test reconstructed frame;
performing encoding and decoding processing on the test estimated frame via a pre-trained estimated frame network of the target video encoding and decoding model, to obtain a second test encoded frame and a second test reconstructed frame; and
determining an encoding and decoding effect of the target video encoding and decoding model based on the first test encoded frame, the second test encoded frame, the first test reconstructed frame, and the second test reconstructed frame.

11. The method according to claim 1, wherein performing encoding and decoding processing on the target video includes:
extracting a target video frame sequence from the target video, the target video frame sequence including a target key frame and a target estimated frame;
performing encoding processing on the to target key frame and the target estimated frame via a pre-trained key frame network and a pre-trained estimated frame network, respectively, of the target video encoding and decoding model, to obtain a first processed encoded frame and a second processed encoded frame; and
performing decoding processing on the first processed encoded frame and the second processed encoded frame via the pre-trained key frame network and the pre-trained estimated frame network, respectively, of the target video encoding and decoding model, to obtain a first processed reconstructed frame and a second processed reconstructed frame.

12. A computer device comprising:
a processor; and
a memory storing computer-readable instructions that, when executed by the processor, cause the computer device to:
extract a video frame sequence from a sample video, the video frame sequence including a key frame and an estimated frame;
perform encoding and decoding processing on the key frame via a pre-trained key frame network of a video encoding and decoding model, to obtain a first encoded frame and a first reconstructed frame;
perform encoding and decoding processing on the estimated frame via a pre-trained estimated frame network of the video encoding and decoding model, to obtain a second encoded frame and a second reconstructed frame;
perform model optimization on the video encoding and decoding model based on the first encoded frame, the first reconstructed frame, the second encoded frame, and the second reconstructed frame, to obtain a target video encoding and decoding model; and
perform encoding and decoding processing on a target video using the target video encoding and decoding model.

13. The computer device according to claim 12, wherein the instructions, when executed by the processor, further cause the computer device to:
obtain an original video meeting a definition condition;
perform boundary detection on the original video, to obtain a scene boundary in the original video;
extract, based on the scene boundary, a video clip including a consecutive scene from the original video; and
obtain the sample video based on the video clip.

14. The computer device according to claim 13, wherein the instructions, when executed by the processor, further cause the computer device to, when obtaining the sample video based on the video clip:
perform artifact removal processing on the video clip, to obtain the sample video.

15. The computer device according to claim 12, wherein the instructions, when executed by the processor, further cause the computer device to:
perform encoding and decoding processing on a video frame in an initial video frame sequence via an initial key frame network, to obtain a third encoded frame and a third reconstructed frame; and
perform parameter optimization on the initial key frame network based on the third encoded frame and the third reconstructed frame, to obtain the pre-trained key frame network.

16. The computer device according to claim 12, wherein the instructions, when executed by the processor, further cause the computer device to:
perform encoding and decoding processing on a video frame in an initial video frame sequence via an initial estimated frame network, to obtain a third encoded frame and a third reconstructed frame; and
perform parameter optimization on the initial estimated frame network based on the third encoded frame and the third reconstructed frame, to obtain the pre-trained estimated frame network.

17. The computer device according to claim 12, wherein the instructions, when executed by the processor, further cause the computer device to, when performing encoding and decoding processing on the key frame:
perform encoding processing on the key frame using an encoder in the pre-trained key frame network, to obtain the first encoded frame; and
perform decoding processing on the first encoded frame using a decoder in the pre-trained key frame network, to obtain the first reconstructed frame.

18. The computer device according to claim 12, wherein the instructions, when executed by the processor, further cause the computer device to, when performing encoding and decoding processing on the estimated frame:
perform encoding processing on the estimated frame using an encoder in the pre-trained estimated frame network, to obtain the second encoded frame; and
perform decoding processing on the second encoded frame using a decoder in the pre-trained estimated frame network, to obtain the second reconstructed frame.

19. The computer device according to claim 12, wherein the instructions, when executed by the processor, further cause the computer device to, when performing model optimization on the video encoding and decoding model:
determine a model loss value based on the first encoded frame, the first reconstructed frame, the second encoded frame, and the second reconstructed frame; and
perform parameter optimization on the video encoding and decoding model based on the model loss value until a convergence condition is met, to obtain the target video encoding and decoding model.

20. A non-transitory computer-readable storage medium storing computer-readable instructions stored that, when executed by a processor, cause a computer device having the processor to:
extract a video frame sequence from a sample video, the video frame sequence including a key frame and an estimated frame;
perform encoding and decoding processing on the key frame via a pre-trained key frame network of a video encoding and decoding model, to obtain a first encoded frame and a first reconstructed frame;
perform encoding and decoding processing on the estimated frame via a pre-trained estimated frame network of the video encoding and decoding model, to obtain a second encoded frame and a second reconstructed frame;
perform model optimization on the video encoding and decoding model based on the first encoded frame, the first reconstructed frame, the second encoded frame, and the second reconstructed frame, to obtain a target video encoding and decoding model; and
perform encoding and decoding processing on a target video using the target video encoding and decoding model.
